(19) United States
(12) Patent Application Publication
(10) Pub. No.: US 2005/0261044 A1
(43) Pub. Date: Nov. 24, 2005

(54) Computer word game

(76) Inventor: Andre M. Persidsky, San Francisco, CA (US)

Correspondence Address: Andre M. Persidsky;#3, 1770 North Point St., San Francisco, CA, 94123, US

(21) Appl. No.: 11/134,718

(22) Filed: May 19, 2005

Related U.S. Application Data
(60) Provisional application No. 60/572,845, filed on May 19, 2004.

(51) Int. Cl. A63F 9/24; A63F 13/00

(52) U.S. Cl. 463/9; 273/272

(57) ABSTRACT

A new computer word game with an action element where word holders fall from the top of the display area, with the goal being to throw letters upwards into each word holder to form a complete valid word in its letter spaces before the word holder reaches the bottom of the display. The player controls a letter selector and selects a letter to throw from a letter depot containing random letters. Word holders appear at random horizontal positions at the top of the display and are of various sizes depending on how many letter spaces they contain. When all letter spaces in a word holder are filled and form a valid word, the word holder disappears and the player is awarded points. If a word holder reaches the bottom of the display before the player has formed a valid word in all its letter spaces, the word holder disappears and the player looses a life. Letters successfully used in a word holder, or lost when the word holder reaches the display bottom are randomly replaced in the letter depot's empty spaces. Depending on the difficulty setting of the game, word holders can fall at various speeds and the interval between the appearances of successive word holders can vary.

### CROSS-REFERENCE TO RELATED APPLICATIONS

This application claims the benefit of provisional patent application Ser. No. 60/572,845 filed May 19, 2004 by the present inventor.

### BACKGROUND OF THE INVENTION

1. Field of the Invention

The present invention relates to computer video games, in particular, to computer based word games.

2. Description of the Prior Art

Many computer word games have been created where the goal involves forming a series of valid words from randomly supplied groups of letters. In a common embodiment, the computer displays random letters in a square matrix, with the player selecting or linking together adjacent letters to form a valid word. Another common embodiment involves selecting letters from a row of randomly generated letters, such as in the software version of Scrabble. In both examples, the letters typically can be selected by clicking them with the mouse pointer in the order corresponding to the desired word. A time limit may be imposed within which a certain quantity of valid words must be formed to reach the next level of the game.

In 1991, Spectrum Holobyte, Inc. introduced a software word game titled “Wordtris” ™. The goal of the game is to arrange falling letters so that when they reach the bottom of the screen or stack on top of other letters, they form complete words either horizontally or vertically and the player is awarded points. When a valid word is formed in this manner, the used letters disappear. Letters not arranged successfully continue to pile up and the game is ended when they pile too high, much like in the popular video game Tetris.

While Wordtris introduced an action element to computer word games, game play can be quite frustrating for several reasons. First, since the player does not control which letter falls next, it is difficult to plan ahead in forming words. As a player begins to form a word, incompatible letters invariably fall, leading to frequent “pile ups” despite best efforts. This leads players to typically form very short words three or four letters long in an attempt to constantly clear letters.

The present invention as will be described proposes a new computer word game with an action element without the frustrating “pile ups” of Wordtris, and wherein the player has control over selecting from a set of letters to be used in the formation of words.

### SUMMARY OF THE INVENTION

The present invention is a new computer based software word game with an action element which can be run on a variety of processor based systems with video displays, including typical desktop computers with Windows or Mac operating systems, laptops, hand held game systems such as the Nintendo Game Boy, ™, game console systems such as Microsoft's XBOX, ™, cell phones, PDA's, and many others. In the game, word holders are falling from the top of the video display area. The goal of the game is to throw letters upwards into each word holder to form a complete valid word in its letter spaces before the word holder reaches the bottom of the display. The player controls a letter selector and selects a letter to throw from a letter depot containing random letters. Word holders appear at random horizontal positions at the top of the display area and are of various sizes depending on how many letter spaces they contain. When all letter spaces in a word holder are filled and form a valid word, the word holder disappears and the player is awarded points. If a word holder reaches the bottom of the display area before the player has formed a valid word in all its letter spaces, the word holder disappears and the player looses a life. Letters successfully used in a word holder, or lost when the word holder reaches the display bottom are randomly replaced in the letter depot's empty spaces. Depending on the difficulty setting of the game, word holders can fall at various speeds and the interval between the appearances of successive word holders can vary.

### BRIEF DESCRIPTION OF THE DRAWINGS

FIG. 1 is a schematic representation on a video display of a preferred embodiment of the computer word game of the present invention at the start of the game showing a word holder having just appeared at the top of the display.

FIGS. 2-4 taken together illustrate a flow chart of the method of playing a preferred embodiment of the computer word game in accordance with the principles of the present invention.

FIG. 5 is a schematic representation of a preferred embodiment of the computer word game of the present invention showing a letter selected by the letter selector.

FIG. 6 is a schematic representation of a preferred embodiment of the computer word game of the present invention showing a letter tossed upwards by the letter selector.

FIG. 7 is a schematic representation of a preferred embodiment of the computer word game of the present invention showing a letter having entered the first letter space in a word holder, and the appearance of the next word holder.

FIG. 8 is a schematic representation of a preferred embodiment of the computer word game of the present invention showing a word holder having a complete valid word formed in all its letter spaces.

FIG. 9 is a schematic representation of a preferred embodiment of the computer word game of the present invention showing the empty spaces in the letter depot replaced with random letters.

FIG. 10 is a schematic representation of a preferred embodiment of the computer word game of the present invention showing a word holder partially filled with letters approaching the bottom of the display area.

FIG. 11 is a schematic representation of a preferred embodiment of the computer word game of the present invention showing the display immediately after a word holder has been deleted after reaching the bottom of the display, with the empty spaces in the letter depot being randomly replaced with as many letters as lost in the word holder, and with a new word holder being immediately created at the top of the display.

FIG. 12 is a schematic representation on a video display of a second embodiment of the computer word game of the present invention.

FIG. 13 is a schematic representation of a second embodiment of the computer word game of the present invention showing the assistant selecting a letter from the letter depot.

FIG. 14 is a schematic representation of a second embodiment of the computer word game of the present invention showing the assistant having selected a letter from the letter depot.

FIG. 15 is a schematic representation of a second embodiment of the computer word game of the present invention showing the assistant throwing a letter into an empty letter space in a falling book.

FIG. 16 is a schematic representation of a second embodiment of the computer word game of the present invention showing a letter having entered a letter space in a falling book.

FIG. 17 is a schematic representation of a second embodiment of the computer word game of the present invention showing a complete valid word having been formed in the letter spaces of a three letter falling book.

FIG. 18 is a schematic representation of a second embodiment of the computer word game of the present invention showing the saved book having been shelved on the bookshelf with the formed as its word title on the spine.

FIG. 19 is a schematic representation of a second embodiment of the computer word game of the present invention showing extended play features of the word game including a gremlin character, a falling bookend, a gold coin in a letter space, a moving hourglass, and special tiles in the letter depot.

FIG. 20 is a schematic representation of a second embodiment of the computer word game of the present invention showing a bonus level where falling books initially contain letters and words must be completed from the given depot letters.

FIG. 21 is a schematic representation of a second embodiment of the computer word game of the present invention showing the game running on a host computer system.

### DETAILED DESCRIPTION OF PREFERRED EMBODIMENTS

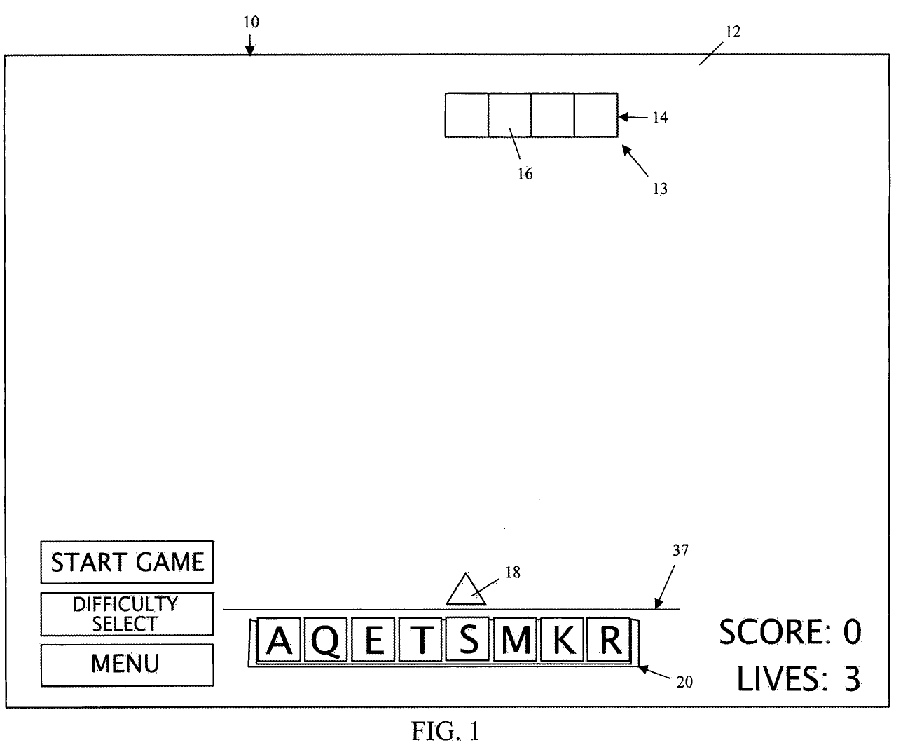

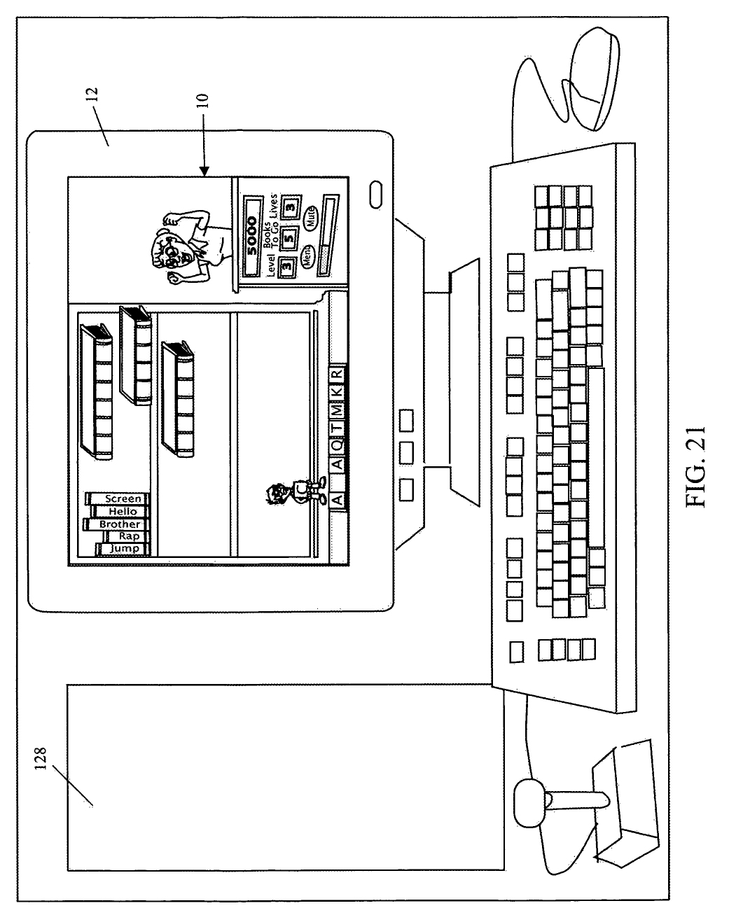

FIG. 1 shows a schematic representation of a first preferred embodiment of a computer word game 10 on a video display 12 of a host computer. Word game 10 is preferably implemented as software containing instructions for controlling a processor, with the game's graphics appearing on the host computer's video display 12. FIG. 21 shows such a host computer 128. Word game 10 can be played on a typical desktop computer or laptop. To play, a user first loads the word game software into the computer and then subsequently runs it to load it into the computer's memory to start the game. Word game 10 can be initially loaded into the computer by CD-ROM or using other digital media storage means, or can be downloaded from the internet. The game is controlled by using the computer's keyboard, or alternately, by using a mouse or joystick as shown in FIG. 21. Once the game begins, a menu driven system can be provided to allow the player to set various game options such as the volume of sound effects, and the level of difficulty. Word game 10 can also be played on portable microprocessor based handheld devices such as PDA's, cell phones, and portable video game systems, in which case, word game 10 is also first loaded into the portable system, and then subsequently run to start the game. Word game 10 can be implemented in many different computer languages such as C++, JAVA, basic, assembly language, Actionscript, Lingo, and others.

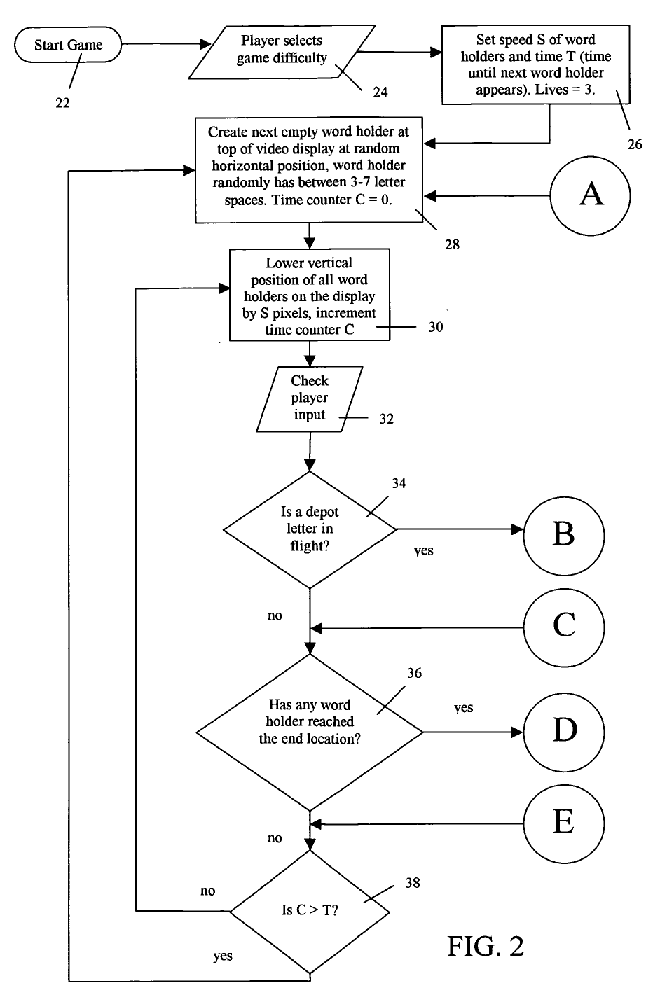

In FIG. 1, a word holder 14 is shown at a starting location 13. Starting location 13 is preferably determined by a random horizontal position at a level near the top of display 12, but other starting locations on display 12 can be used as well. Word holder 14 contains letter spaces 16. A letter selector 18 is located near the bottom of display 12, and above a letter depot 20, containing a set of random letters. The method for playing the first embodiment of word game 10 is now described as according to the flow charts in FIGS. 2-4.

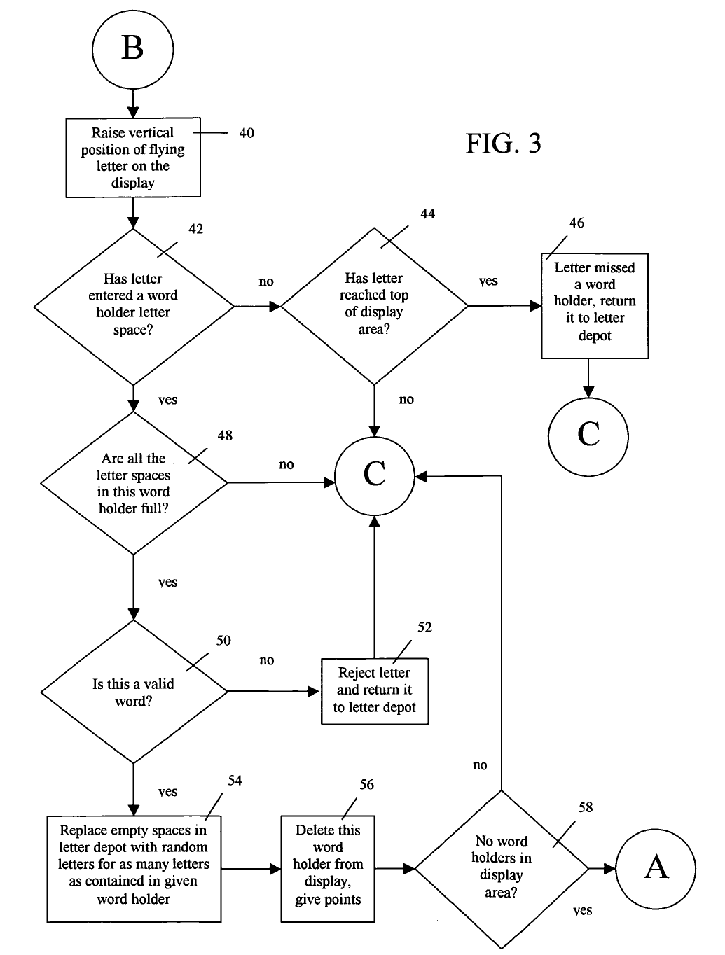

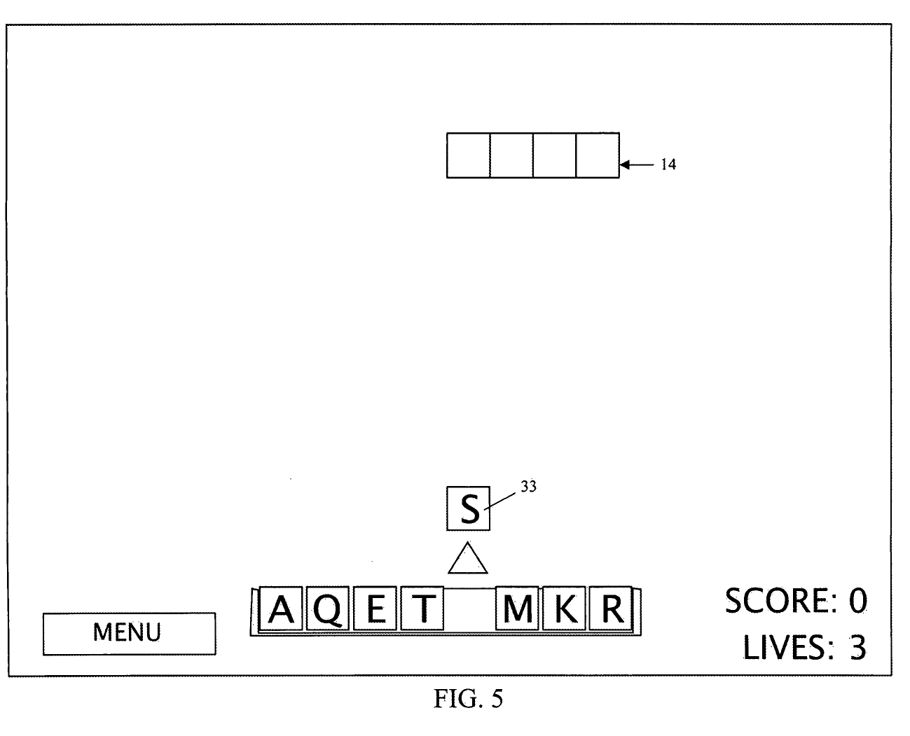

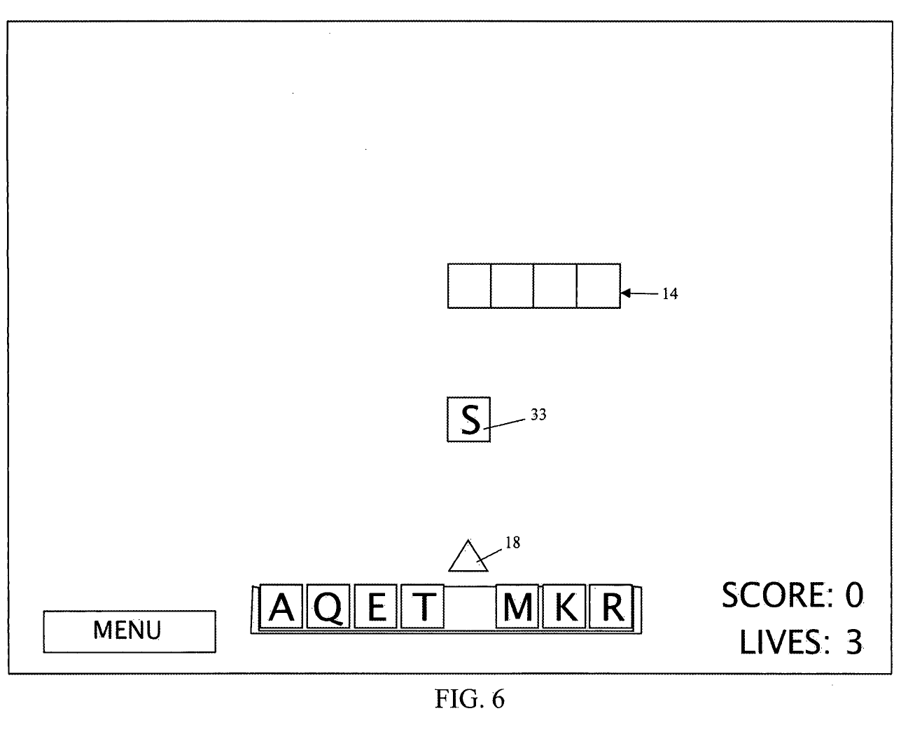

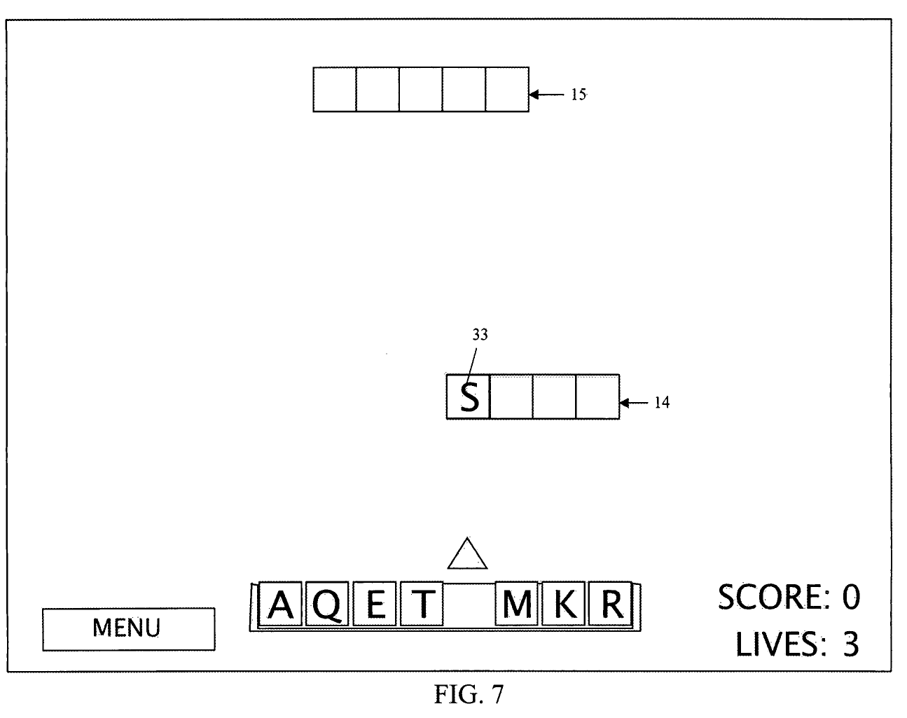

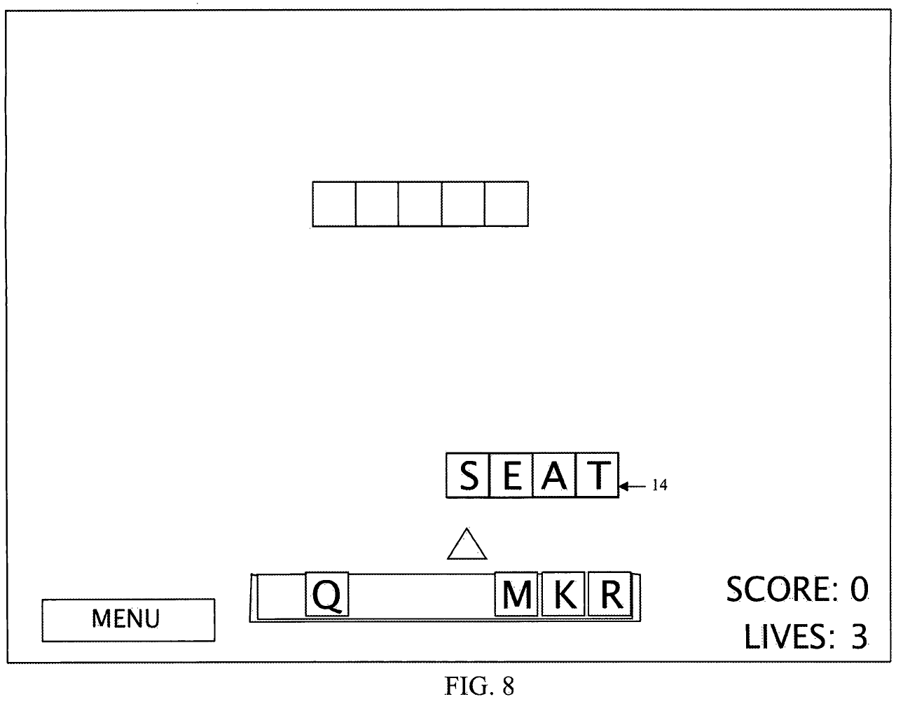

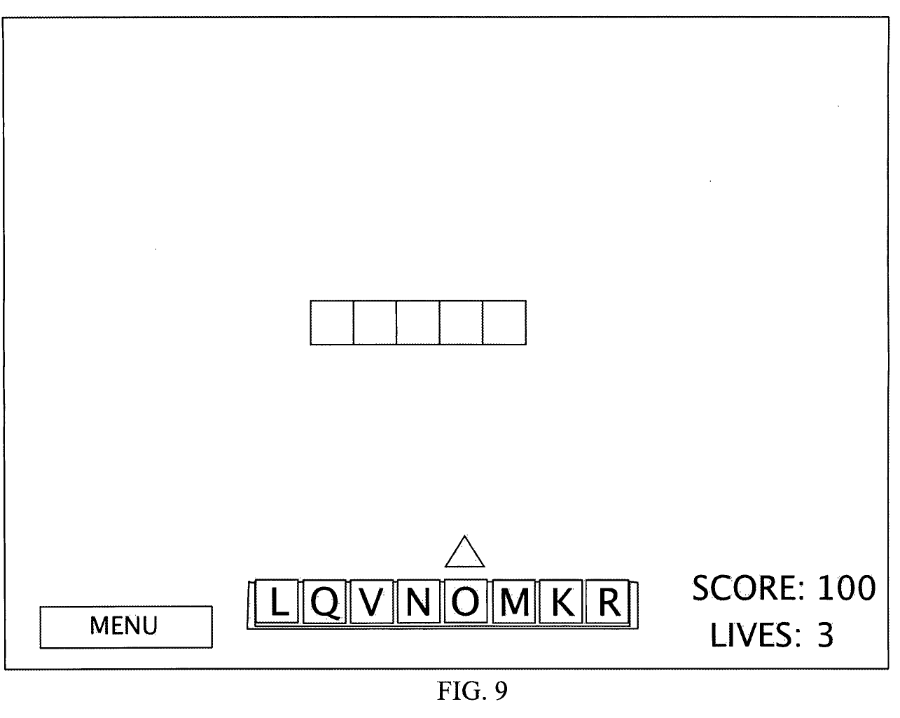

As shown in FIG. 2, a player first starts the game 22 and then selects the difficulty setting 24. From this point forward, one pass through the flow charts in FIGS. 2-4 can be considered as a single frame cycle in the processing of word game 10. The speed S at which the word holders 14 fall vertically and the time T between the appearances of successive word holders 14 is then set by word game 10 depending on the difficulty setting chosen 26. A Lives variable is set to 3 or any desired initial quantity. Game play begins 28 when an empty word holder appears at the top of display 12 at a random horizontal position and with a randomly chosen quantity of empty letters spaces, preferably between 3 to 7 spaces, but more may be used if desired. Time counter C is set to 0. The vertical position of all word holders on display 12 is lowered by S pixels, and time counter C is incremented 30. Player input is checked 32. The player controls letter selector 18 by using a standard input device such as the keyboard, mouse, trackpad, joystick, or others. The player can move letter selector 18 left and right, select a letter from letter depot 20, exchange or return a letter back to letter depot 20, and throw a selected letter upwards towards falling word holders 14. FIGS. 5-6 show a letter selected and then thrown using letter selector 18. Letter selector 18 can move a distinct distance either left or right to always be in alignment with a letter space 16 of any word holder 14 above it. If a depot letter is in the process of flying upward 34, the processor raises 40 (FIG. 3) the vertical position of any flying letter 33 (as shown in FIG. 6). More than one letter may be flying upwards at any one time. The processor then tests 42 if a flying letter 33 has entered a letter space in a word holder. If no, then the processor checks 44 if flying letter 33 has reached the top of display 12. If yes, then the player has missed a word holder and flying letter 33 is returned to the empty space in letter depot 20. If flying letter 33 has entered a letter space in a word holder 14 (FIG. 7), the processor then checks if all the letter spaces in this word holder are full 48. If yes, the processor checks if this is a valid word 50. An electronic database of valid words is included in word game 10 against which the processor can make this comparison. If the word is not valid 52, flying letter 33 is rejected and returned to the empty space in letter depot 20. Flying letter 33 may immediately be erased from word holder 14 and reappear in letter depot 20, or alternately, flying letter 33 may be thrown downwards out of word holder 14 as a rejection animation (not shown) and appear in letter depot 20 when it reaches the bottom of display 12. If the word formed in word holder 14 is a valid word (FIG. 8), then the processor replaces 54 (FIG. 3) the empty spaces in letter depot 20 with random letters for as many letters as contained in the given word holder 14, word holder 14 is deleted 56 from display 12, and points are added to the player's score. Points awarded may depend on the size of the word holder or length of the word formed. As shown in FIGS. 8-9, the valid word “SEAT” has been formed in word holder 14, and the four empty letters in letter depot 14 have been randomly replaced with the letters “LVNO”. After word holder 14 is deleted from display 12, if no other word holders are falling, the processor returns to 28 immediately creating another random word holder without waiting for time T to be exceeded, and resetting time counter C to 0. Multiple word holders may be falling on display 12 at any one time, and the player can form words in the word holders in any order he/she wishes, either fully or partially, provided that the letter spaces in the targeted word holder are not blocked by other word holders located lower on display 12, because a flying letter 33 enters the first letter space it hits. If a letter space in a word holder already contains a letter when hit with another letter, the previous letter may be exchanged and returned to letter depot 14 as the new letter takes its place.

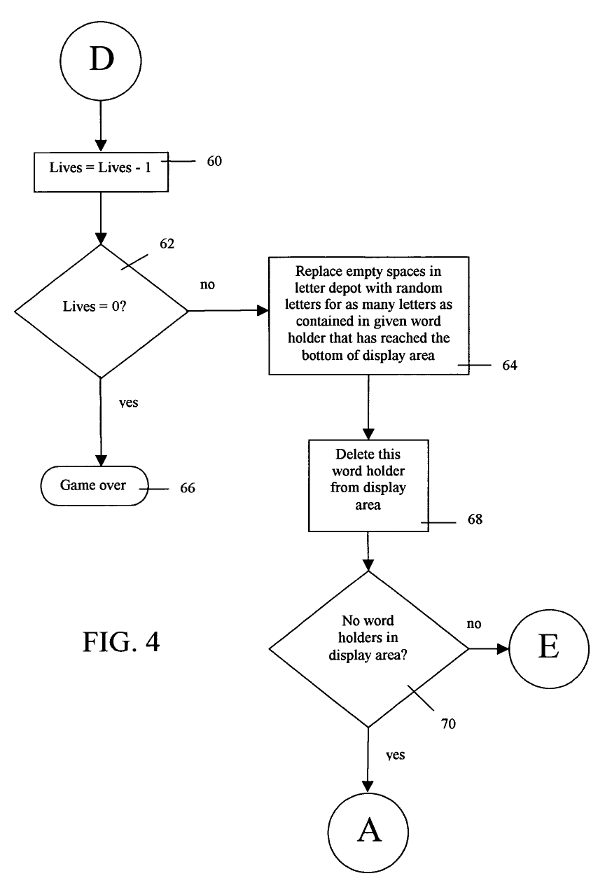

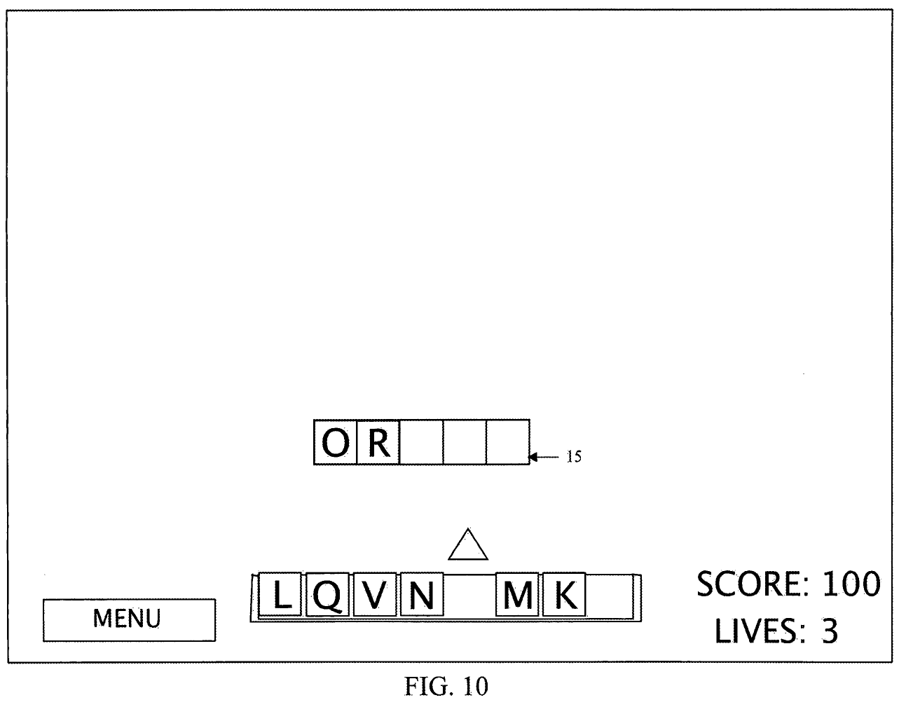

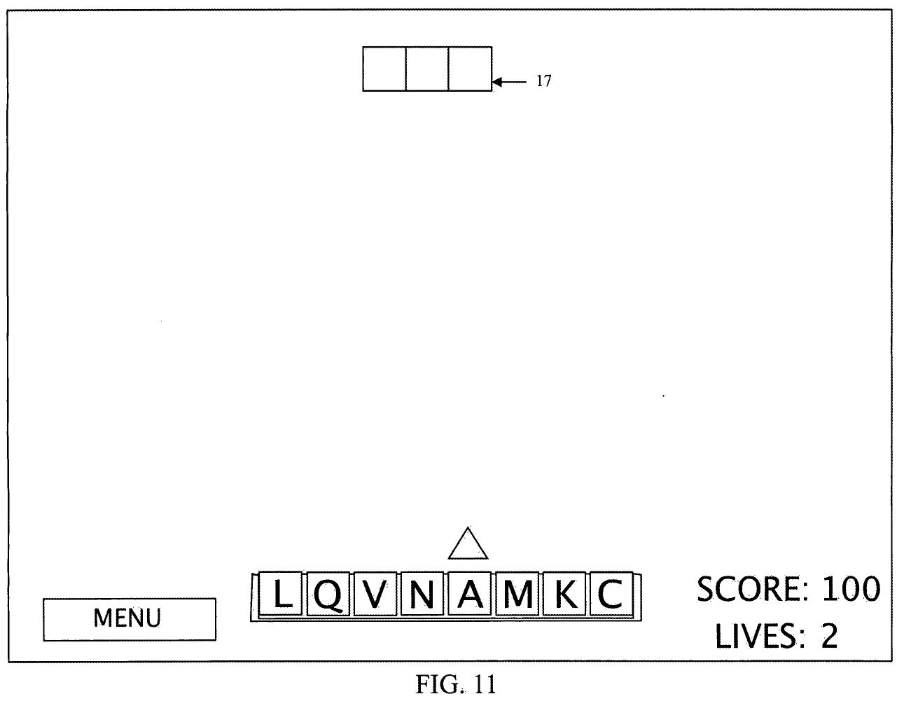

Referring back to the program flow in FIG. 2, the processor tests 36 if any word holder has reached an end location 37 as shown in FIG. 1. End location 37 is preferably at a level near the bottom of display 12 and may be marked by an indicator such as a horizontal line, but may be at other locations on display 12 as well. If no word holders have reached end location 37, the processor then tests if time counter C has exceeded T, the time interval between successive word holders. If no, the processor loops back to 30. If yes, the processor returns back to 28 and creates the next random empty word holder as shown in the example in FIG. 7, with a five letter word holder 15 appearing at the top of display 12. If a word holder 14 has reached end location 37, the processor then decrements 60 the Lives variable by one as shown in FIG. 4. If Lives=0, then the game is ended 62 and 66. If Lives>0, then the processor replaces 64 the empty spaces in letter depot 20 with random letters for as many letters as lost in the given word holder 14, word holder 14 is deleted 68 from display 12, and no points are added to the player's score as shown for five letter word holder 15 in FIGS. 10-11. After word holder 14 is deleted from display 12, if no other word holders are falling, the processor returns to 28 (FIG. 2) immediately creating another random word holder 17 (FIG. 11), and resetting counter C to 0.

Word game 10 is primarily intended to be played in the English language using the standard English alphabet to form words in the falling word holders, but can also be extended to many other languages such as but not limited to Russian, Spanish, French, German, Italian, and others. New letters appearing in letter depot 20 may appear randomly, but also may appear randomly but in proportion to the letter frequencies for the language. For example in English, “E” is much more common than “Z” and would thus appear much more frequently in the letter depot.

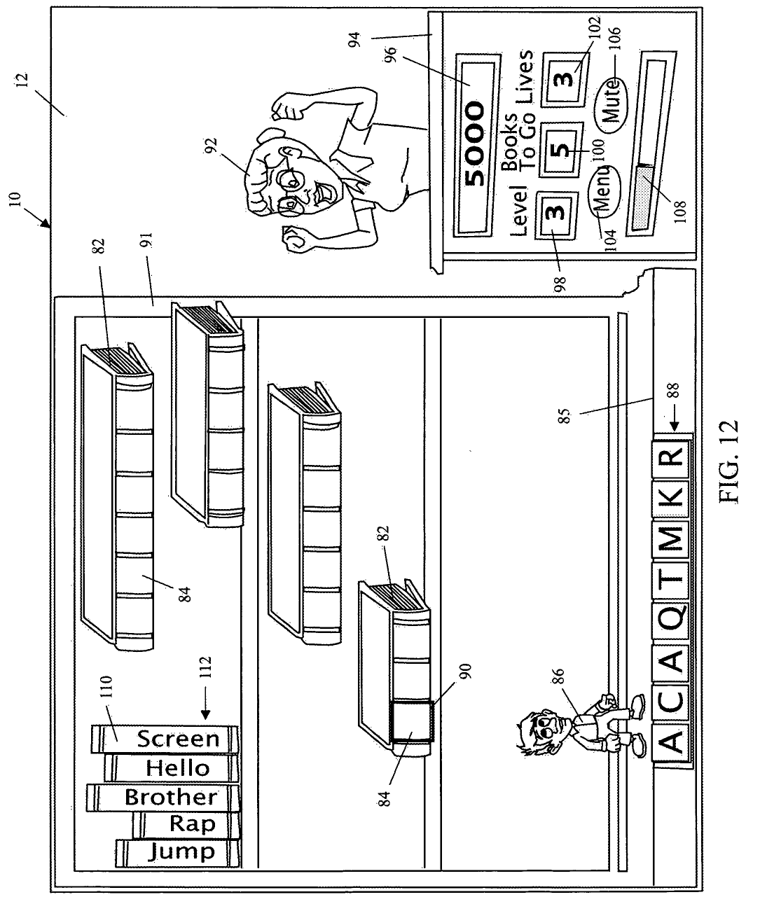

A second embodiment of word game 10 is shown in FIG. 12, having extended game play features, and incorporating a graphical theme of a library. Word holders are implemented as falling books 82, with the spines of the books facing the player and containing letter spaces 84. A book 82 is saved when a valid word is formed in all its letter spaces before it reaches a base 85 at the bottom of a bookshelf 91. If it hits base 85 without a valid word being formed, it crashes and a life is lost. As part of the game theme, a player is thus attempting to title the untitled falling books. FIG. 21 shows the second embodiment of the present invention running on a host computer system 128, with the game being displayed on its video display

Books 82 are of varying lengths depending on the quantity of letter spaces 84 they contain. In this second embodiment, the letter selector is implemented as a librarian assistant character 86. A letter depot 88 can be implemented as a letter rack and the letters can be encased in tiles. Assistant 86 can be controlled by keyboard to move him left and right, and to select, toss, or return letters back to letter depot 88. Additional commands for assistant 86 may be provided such as undoing the last letter toss, and extracting a letter out of a letter space in a falling book. As shown, letter depot 88 can hold up to eight letters, but a lower or higher limit may be imposed as desired. When assistant 86 stands beneath a letter space in a falling book, that space is highlighted by a square outline 90 to help the player know which letter space is targeted. A librarian character 92 is seated behind a desk 94. Desk 94 contains a score indicator 96, a level indicator 98, a “Books To Go” indicator 100, a Lives indicator 102, a menu button 104, a mute button 106, and a charger bar 108. “Books To Go” indicator 100 displays the remaining quantity of falling books on the current level. Each time a book is saved or crashes at base 85 of bookshelf 91, “Books To Go” indicator 100 is decremented by one. When this indicator reaches zero, the level is complete.

Much like in the previous embodiment, letters in letter depot 88 are progressively replaced during play with random letters as books are saved or lost while containing incomplete words. But sometimes the letter set in letter depot 88 may prove undesirable to the player, such as if it contains several “Q”′ letters, or lacks vowels. In this case, the player may be able to obtain a new random letter set for the entire letter depot 88 through a re-rack command which can be invoked by pressing the “Z” key for example, or through other non-keyboard input means. The re-rack command only functions when charger bar 108 is fully charged, so that the player must wait a predetermined time interval between re-racks as charger bar 108 fills up. Additionally, points may be deducted when the re-rack command is used. Since the re-rack command refills the entire letter depot 88, including any empty spaces, the letters normally replaced during the course of books being saved or lost may not be since those letters are only replaced when there are empty spaces available in the letter depot. The re-rack command also allows more than eight letters to be in play on display 12 at any given time.

Librarian 92 can be an animated character that expresses various gestures and poses in response to specific events during game play. For example, when a book is filled with a valid word, librarian 92 may smile and nod. If a book reaches the bottom of bookshelf 91 without being completed, librarian 92 may sigh and lower her head in disappointment.

Bookshelf 91 serves as a backdrop, and also to display the progress of words successfully formed on a given level. Each time a book is saved, a shelved book 110 can appear in the next available space 112 on bookshelf 91 with a title corresponding to the word formed. The same word cannot be formed more than once on any given level. Decorative filler books (not shown) may be provided on bookshelf 91 to the right of the entire space intended for shelved books 110. The space allocated for shelved books 110 between the left edge of bookshelf 91 and the first decorative book can correspond to the initial quantity of “Books To Go” on the given level. With this approach, if a player saves all the falling books on a given level, this entire space is filled, and thus the entire bookshelf 91 may appear filled if all the other spaces on its shelves contain decorative filler books. If the player fails to save one or more books on a given level, a gap between shelved books 110 and the decorative filler books may be visible on bookshelf 91. An end of level reward animation can be provided when all books are saved in the form of the shelved books moving up and down successively in a wave pattern. Alternately, if one or more books are lost, an animation can be provided where the decorative filler books tip over one by one like dominoes towards the gap formed between the shelved books and filler books.

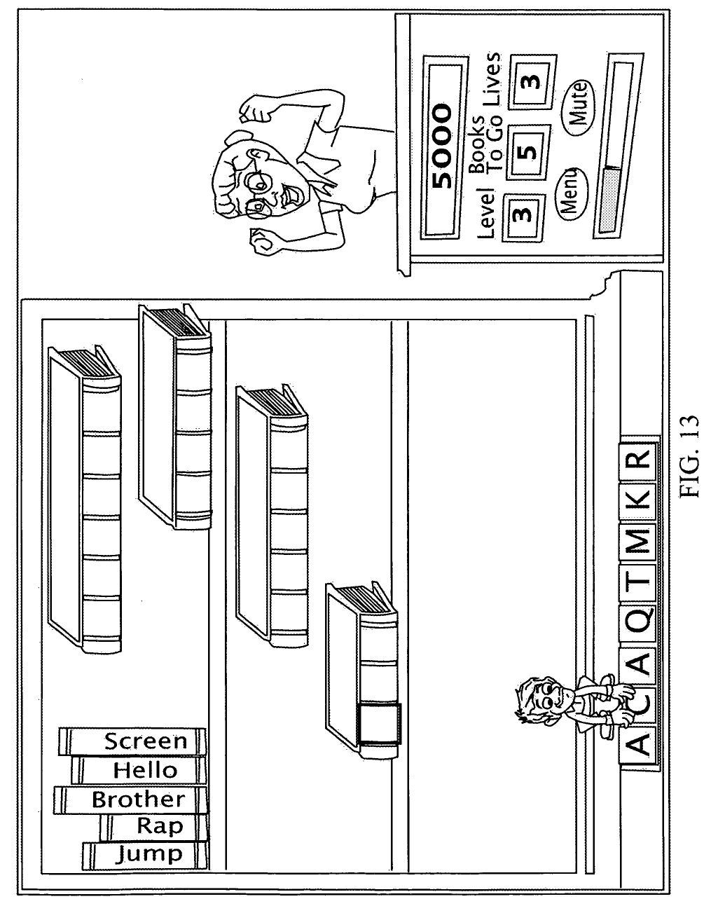

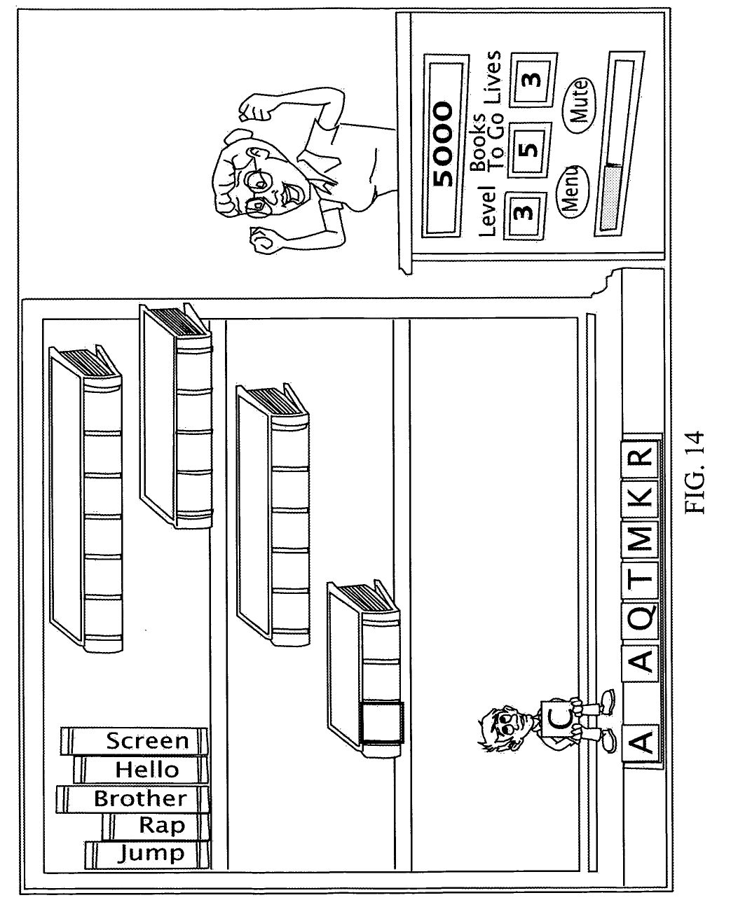

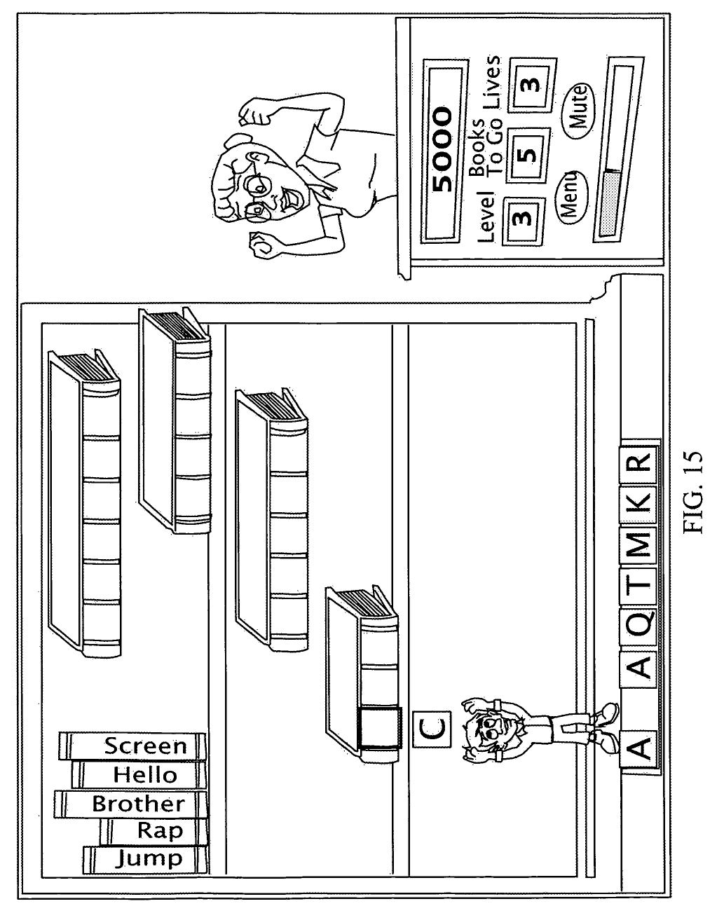

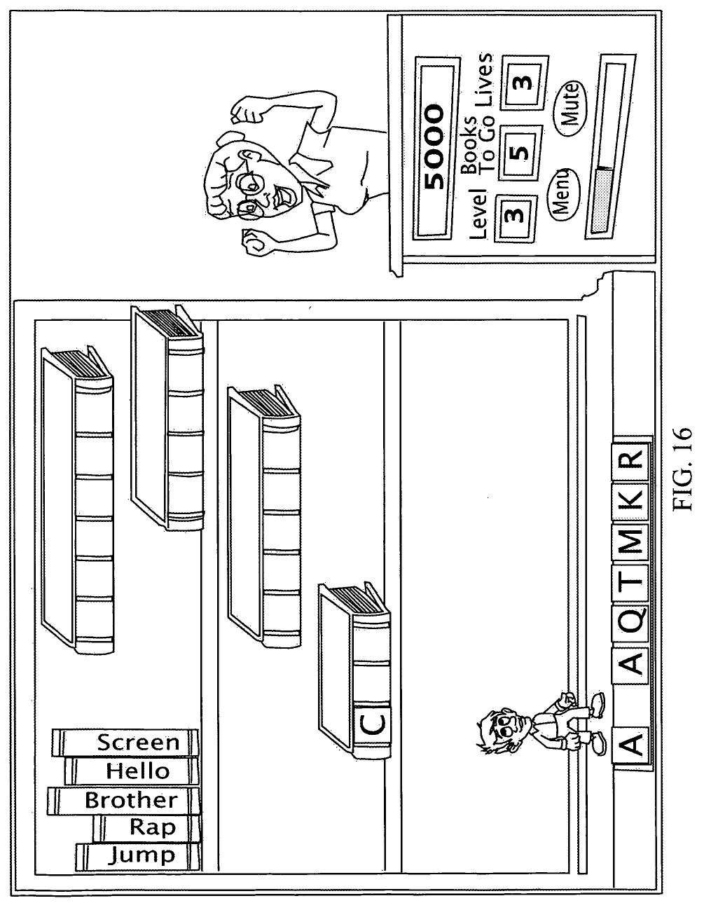

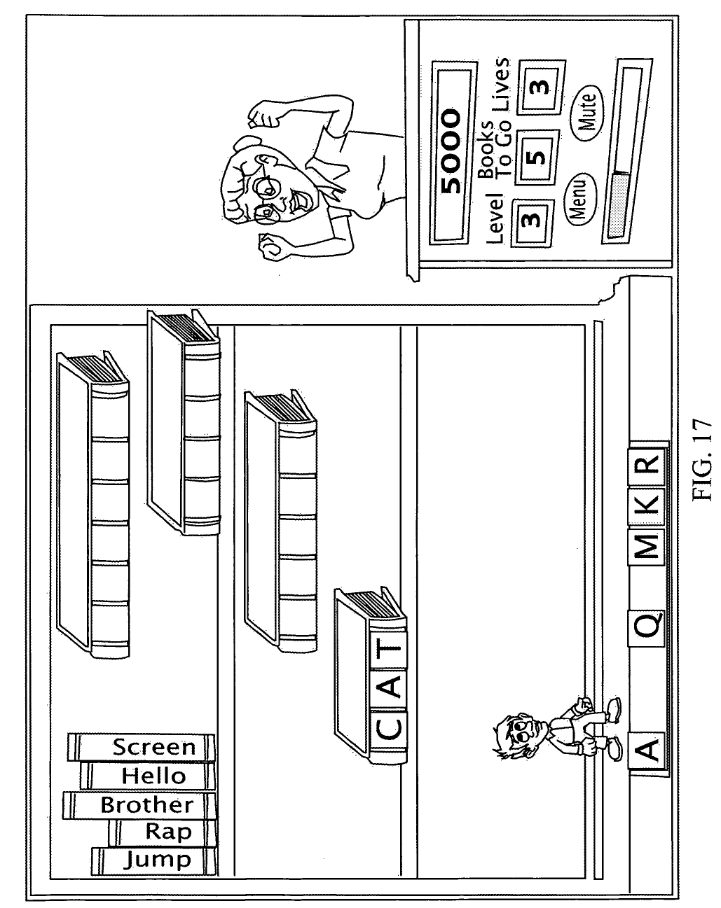

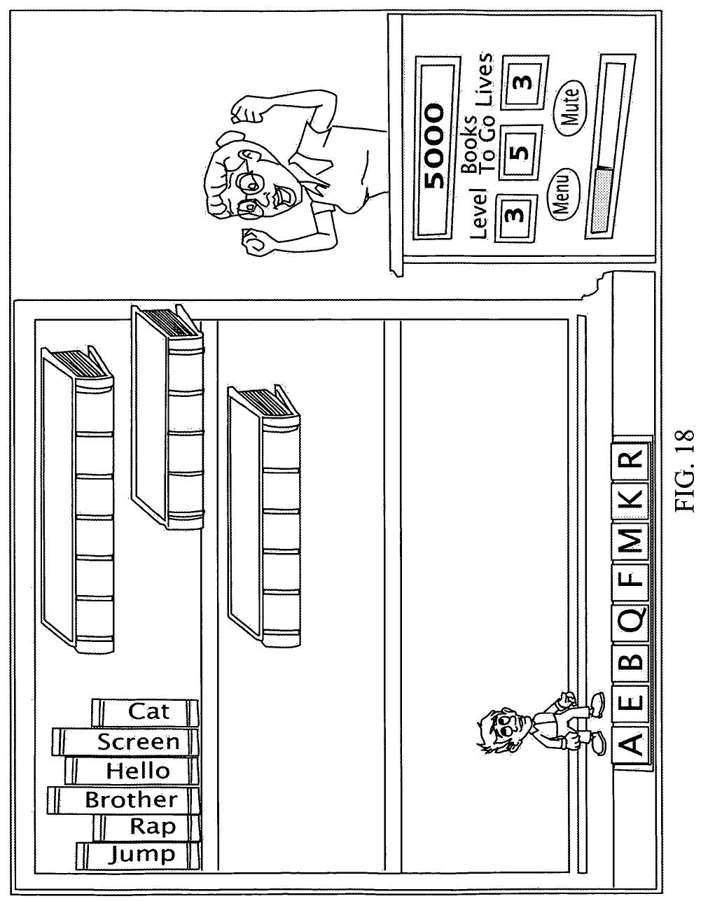

FIGS. 12-18 show the complete sequence for saving an instance of a falling book 82, in this particular example, a book with three letter spaces. Using assistant 86, a player first selects the desired letter, then positions the assistant beneath the desired letter space in a falling book. The player then throws the letter, and shortly afterwards, it enters the letter space. This process is repeated until a valid word is formed such as “CAT” in all the letter spaces of a given book. The book is then automatically shelved onto the bookshelf where it appears vertically with the spine facing out with its new word title displayed. A shelving animation may be provided where the book flies and rotates into its shelved space.

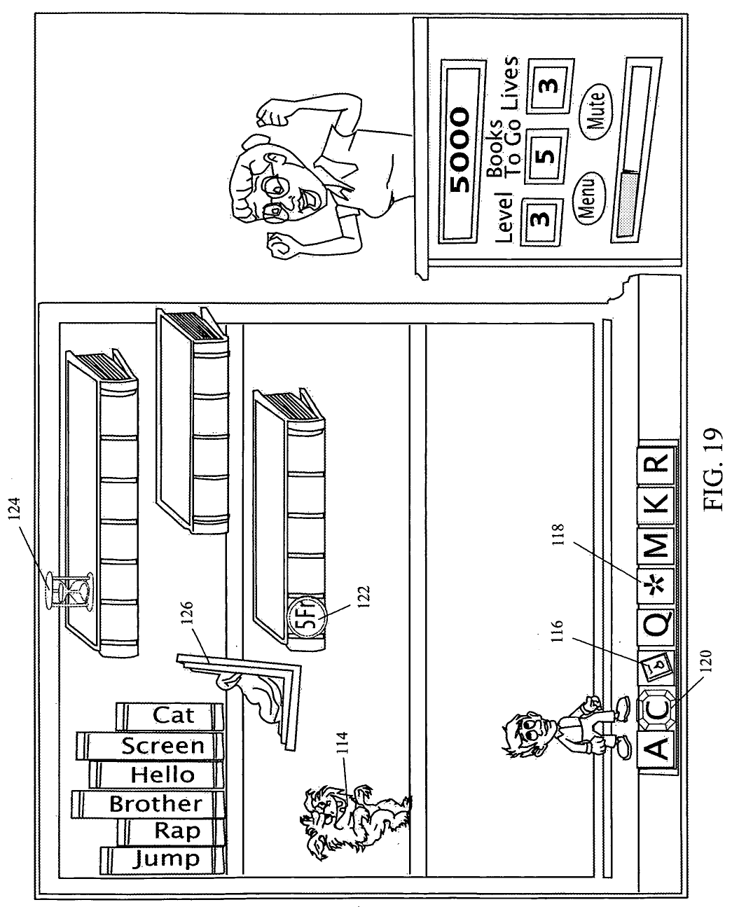

Additional game elements may be provided in word game 10 to add variety as levels progress. In addition to the “Books To Go” quantity increasing on subsequent levels, an animated gremlin character 114 can be included as shown in FIG. 19. Gremlin 114 can appear at random intervals, and walks across bookshelf 91. If the player hits the gremlin with two tossed vowel letters before the gremlin reaches the opposite end of the bookshelf, gremlin 114 falls and a special glowing tile 116 is placed in letter depot 88. Glowing tile 116 can immediately upon impact shelve and clear any book. Additional thematic characters can appear such as moths, mice, and spiders (not shown), which also respond when being hit by one or more vowels to provide additional special tiles with unique functions. For example, when a moth is hit with a single vowel, an asterisk tile 118 can be placed in letter depot 88. Asterisk tile 118 can be used as a wildcard letter to function as any letter. Gem tiles 120 can periodically appear in letter depot 88, which when successfully used in a book, triple its points. Letters infrequently used such as “Z”, and “Q” can be provided on gold tiles in letter depot 88, and are worth more points due to the increased difficulty of forming words with them. Gold coins 122 can randomly appear in book letter spaces. When a letter enters a space with a gold coin, the letter can be promoted to a high value tile, such as a gold tile or a gem tile. Additionally, an hourglass 124 may randomly appear on some books. Hourglass 124 moves from left to right and disappears when it reaches the right end of a book. If the player saves a book before hourglass 124 disappears, more points may be awarded. On certain levels, falling bookends 126 may appear which the player must avoid. If it hits assistant 86, a life is lost. It is thus an object of the present invention as illustrated by these examples to combine arcade action skills with traditional word solving skills to create a novel word action game.

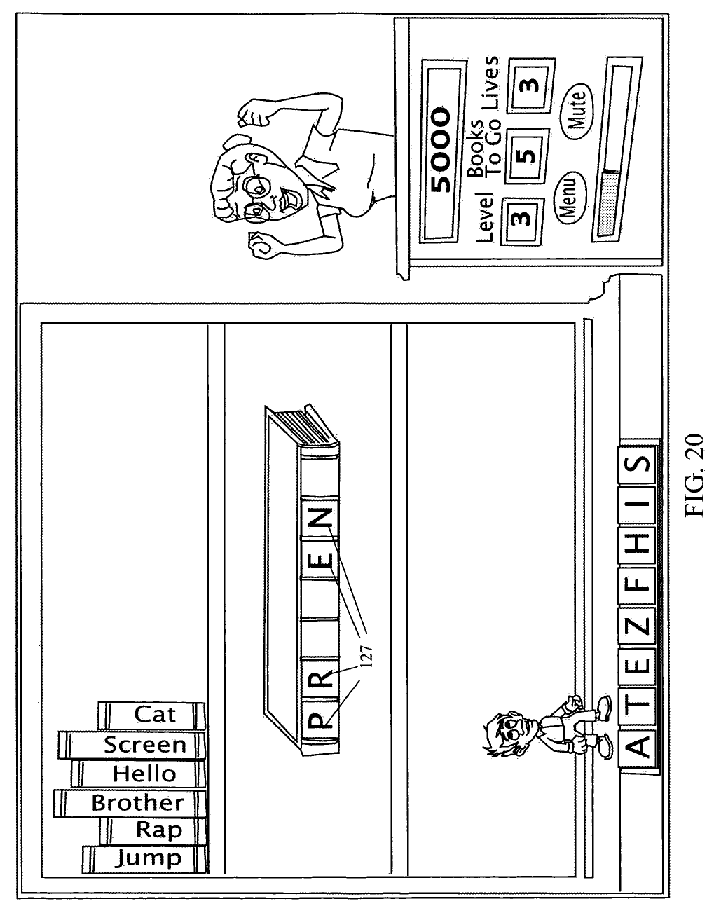

As shown in FIG. 20, a bonus level can be provided with a different mode of play. On the bonus level, a falling book can appear with existing letters 127 in some of its letter spaces. The goal is to recognize and complete the incomplete word in the usual manner by tossing letters into it. Existing letters 127 may be permanently set in the letter spaces so that they cannot be replaced. Letter depot 88 contains the necessary letters to complete the given word in addition to random letters to make the job more difficult. In FIG. 20, the falling seven letter book contains the letters “PR_EN_”. The incomplete word is “PRESENT” with the “E”, “S”, and “T” located in the letter depot. The re-rack feature is disabled in this mode. As an alternative to completing incomplete words, the letter depot on the bonus level could feature a scrambled word such as “SBOOIVU” for “OBVIOUS” which the player has to recognize and unscramble in time, by tossing the letters in the right order into the falling book before it reaches the bottom.

It should be noted that word game 10 can be implemented using many other graphical themes other than a library and books without changing the essence of the invention. For example, a science fiction theme could be used, where the letter selector shoots or zaps letters into descending spaceships functioning as the word holders. The word holders can be implemented as any kind of form or shape such as but not limited to clouds, animals, cars, rockets, trains, airplanes, and many others.

As an alternative arrangement within the scope of the present invention, word game 10 can be arranged so that the player drops letters downwards from the top of display 12 into ascending word holders, which initially appear at the bottom of the display, in which case, starting location 13 and end location 37 would be swapped. Similarly, the player could toss letters horizontally into word holders also moving horizontally from the opposite side of the display. The range of distance traveled by the word holders need not cover the entire width or height of the video display, but could be a partial range so that the word holders could start moving from an arbitrary initial starting location 13 on the display, towards another arbitrary end location 37 in either a straight or angled line, with the letter selector having the chance to fill the empty letter spaces in the word holders between these two locations. The letter selector need not necessarily throw, toss, or propel a letter from itself to a designated letter space, but could cause the selected letter to immediately appear in the designated letter space without moving through the distance between the letter space and letter selector. The letter depot need not necessarily be beneath the letter selector. For example, it could reside beside or above the letter selector, or at a different location relative to it.

Although the description above contains may specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A computer programmed to display a word game on a display associated with said computer, comprising:
At least one word holder appearing on said display at a starting location, said word holder moving from said starting location towards an end location, said word holder containing a plurality of letter spaces.
A letter selector appearing on said display;
A letter depot containing a plurality of letters on said display;
Input means for the player to control the position of said letter selector on said display, to select a letter from said letter depot, and to place a selected letter into a said letter space in said word holder.
A processing means to determine if said letters placed into said word holder form a complete valid word.
Whereby if the user forms a complete valid word in a word holder before said word holder reaches said end location, the player is awarded points.

2. The word game of claim 1, wherein said input means comprises a keyboard.

3. The word game of claim 1, wherein said word holder is represented on said display by a book.

4. The word game of claim 3, wherein said book further comprises a spine, said letter spaces contained in said spine.

5. The word game of claim 1, wherein the player throws a selected letter upwards towards a word holder for placing said selected letter into a said letter space in said word holder.

6. The word game of claim 1, wherein said starting location is near the top of said display, and said end location is near the bottom of said display.

7. The word game of claim 1, wherein said computer includes a memory for storing a database of words.

8. A method of playing a word game displayed on a video display, comprising the steps of:
Displaying a word holder at a starting location on said display, said word holder containing a plurality of letter spaces;
Moving said word holder towards an end location on said display;
Selectively controlling a letter selector on said display for placing letters contained in a letter depot on said display into said letter spaces in said word holder;
Testing if said letter spaces in said word holder contain a valid word;
Awarding points if said word holder is filled with a valid word before said word holder reaches said end location.

9. The method of claim 8, wherein said letter selector is controlled by a keyboard.

10. The method of claim 8, wherein said word holder is represented on said display by a book.

11. The method of claim 10, wherein said book further comprises a spine, said letter spaces contained in said spine.

12. The method of claim 8, wherein the player throws a selected letter upwards towards a word holder for placing said selected letter into a said letter space in said word holder.

13. The method of claim 8, wherein said starting location is near the top of said display, and said end location is near the bottom of said display.

14. The method of claim 8, wherein said computer includes a memory for storing a database of words.
